(19) United States
(12) Patent Application Publication
(10) Pub. No.: US 2009/0004990 A1
(43) Pub. Date: Jan. 1, 2009

(54) AUTOMATIC GAIN CONTROL LOCKED ON TO THE RECEIVED POWER PROBABILITY DENSITY

(75) Inventors: Alain Renard, Chabeuil (FR); Estelle Kirby, Valence (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/124,345

(22) Filed: May 21, 2008

(30) Foreign Application Priority Data
May 25, 2007 (FR) 07 03735

(51) Int. Cl. H04B 1/10

(52) U.S. Cl. 455/296

(57) ABSTRACT

The invention relates to a radio receiver, notably for applications of satellite positioning, that must operate in an environment in which the interference is dense, notably when it involves pulses transmitted by DME beacons. The effective processing of the interference assumes having an unbiased noise reference. According to the invention, the latter is generated by a signal power probability function analysis in its portion essentially comprising low-power signals.

### RELATED APPLICATIONS

The present application is based on, and claims priority from, French Application Number 07 03735, filed May 25, 2007. The present application is related to U.S. patent application No. 12/124,228, filed May 21, 2008, the disclosures of which are hereby incorporated by reference herein in their entireties.

### FIELD OF INVENTION

The present invention applies to radio receivers that must receive weak signals in a pulsed interference environment. It is notably the case of positioning receivers that use the signals received from constellations of GNSS (Global Navigation Satellite Systems) satellites such as the GPS (Global Positioning System) systems and enhanced GPS, GLONASS (Global Orbiting Navigation Satellite System) and, in the near future, Galileo.

### BACKGROUND OF THE INVENTION

The received signal is typically situated a few tens of dB below the thermal noise of the receiver. The processing of the signal must make it possible to recover one or more carriers and one or more modulation codes of said carriers which comprise information characteristic of the satellite transmitting said carriers. The central portion of the digital processing is a correlation of the received signals with local replicas of said signals. These processes assume a minimum correlation input signal-to-noise ratio of approximately ten dBHz. This minimum is not reached in the presence of interference which saturates the receiver to the point of very substantially corrupting the payload signal. It is typically the case of signals allowing location relative to remarkable points on the ground of the DME (Distance Measuring Equipment) system. The beacons on the ground transmit signals in response to the interrogation signals transmitted by the aircraft. These ground beacons and the onboard interrogators transmit signals of high instantaneous power (of the order of approximately ten kilowatts) in the frequency bands used for the positioning signals (around 1200 MHz).

A known solution to this problem is notably the technique called “blanking” which consists in identifying the interfering signal and deleting subsequent processing of the received signal disturbed by the latter. This solution does not work when the density of interference increases to the point of virtually permanently covering the payload signal. In this case, blanking leads to eliminating any payload signal at the same time as the interfering signal. This type of scenario is likely to occur in a large portion of European air space, notably at an altitude of the order of 40 000 feet where the number of DME beacons seen by an aircraft may be of the order of 60 at times of maximum traffic density. It is possible, in order to enhance the effectiveness of the blanking, to cut the band into several subbands and to carry out the blanking on each of the subbands, which, for given interference, allows a larger part of the payload signal to subsist and therefore enhances the signal-to-noise ratio.

In both cases, it is necessary to have a noise reference that makes it possible to dispense with the thermal noise estimation bias which appears in dense interference scenarios. One solution consists in calibrating a noise reference, but this solution is stable neither in time nor in temperature nor with reference to the dynamic to which the receiver is subjected. The general problem that is not solved by this prior art is to supply an estimate of the thermal noise without having to use calibration. A solution such as that which is disclosed notably by U.S. Pat. No. 5,101,416 is to carry out a locking-on of the automatic gain control of the receiver as a function of the probability density of the signal amplitude. This solution however cannot be adapted to scrambling scenarios that may be variable. The present invention solves this problem.

### SUMMARY OF THE INVENTION

Accordingly, the present invention proposes a device for receiving a radio signal comprising a module for estimating a characteristic magnitude of said signal chosen from the group amplitude, power, an automatic gain control module of the receiver, and a module for analyzing the probability density function of said characteristic magnitude whose parameters can be adjusted to supply inputs to the automatic gain control module which ensure a substantially optimal gain of the receiver, wherein the probability density function analysis module comprises a sub-module for calculating an averaged histogram of said function and a sub-module for determining the noise by comparison to an priori chosen statistic.

Advantageously, the noise determination sub-module performs a breakdown of the histogram into a sum of laws of X² and determines the one which is the most probable law representative of the noise.

Advantageously, the noise determination sub-module performs a breakdown of the histogram into a sum of laws expected for the interferences and laws expected for the noise.

Advantageously, the noise determination sub-module performs a correlation of the histogram of the signal with a histogram of the noise according to an expected law.

Advantageously, the reception device according to the invention also comprises an interfering signal processing module at the output of the probability density function analysis module.

Advantageously, the interfering signal processing module carries out a blanking whose threshold is calculated by reference to the noise estimated by the probability density function analysis module.

Advantageously, the interfering signal processing module carries out several blankings in frequency sub-bands of the signal, each blanking threshold being calculated by reference to the noise estimated by the probability density function analysis module.

Advantageously, the interfering signal processing module carries out an inversion of a characteristic magnitude of the signal chosen in the group amplitude, power based on the output of the estimation module.

The invention also discloses a method for processing a radio signal comprising a step of estimating a characteristic magnitude of said signal chosen in the group amplitude, power, a step of controlling automatically the gain of the receiver and a step of analyzing the probability density function of said characteristic magnitude whose parameters can be adjusted to supply inputs to the automatic gain control step to ensure a substantially optimal gain of the receiver, wherein the probability density function analysis step comprises a sub-step for calculating an averaged histogram of said function and a sub-step for determining the noise by comparison to a previously chosen statistic.

The invention also has the advantage of allowing a reduction of the dynamic of the signal processing operators because of the gain matching that results therefrom.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents the amplitude as a function of time of the pulsed interference transmitted by a DME beacon;

FIG. 2 represents the histogram of the powers of the pulsed interference transmitters received by an aircraft at the most scrambled point of European airspace as a function of the frequency;

FIG. 3 represents the histogram of power as a function of the signal amplitude with and without interfering pulsed signal in the band E5b of the Galileo signal;

FIG. 4 represents an enlarged view of FIG. 3;

FIG. 5 represents the histogram of FIG. 3 in total probability;

FIG. 6 represents an enlarged view of the left portion of the curve of FIG. 5;

FIG. 7 represents a schematic diagram of the functional architecture of the portion of a positioning radio receiver using the invention;

FIG. 8 represents the functional architecture of the portion of a positioning radio receiver using the invention in an embodiment in which the histogram is broken down into Rayleigh laws (expected form of the thermal noise only) and determination of the most probable;

FIG. 9 represents the breakdown of the power probability density function into noise component and other components.

In the description and the figures, the symbols, acronyms, formulas and abbreviations have the meaning indicated in the table below.

| Symbol | Meaning |
|---|---|
| λ | Carrier wavelength |
| σ | Standard noise deviation at the output of the low-pass |
| | filter |
| ADC | Analog Digital Converter |
| AGC | Automatic gain control |
| Alphaᵢ | AGC adjustment parameters |
| Blanking | Deletion of the payload signal in the presence of |
| | interference |
| CM | Core Module |
| DME | Distance Measuring Equipment |
| e | Received signal |
| EUROCAE | European Organization for Civil Aviation Equipment |
| f(a) | Optimal nonlinear function of Gaussian noise |
| FDAF | Frequency Domain Adaptive Filtering |
| FIR | Finite Impulse Response filter |
| FPGA | Field-Programmable Gate Array |
| GNSS | Global Navigation Satellite System |
| GPS | Global Positioning System |
| ISWᵢ | Input set point parameters of the high portion of the CM |
| JTIDS | Joint Tactical Information Distribution System |
| LO | Local Oscillator |
| LSB | Least Significant Bit |
| MIDS | Multifunctional Information Distribution System |
| Noise_diff | Thermal noise coding difference |
| OSWᵢ | Outputs of the high portion of CM |
| P₀₁, P₀₂, P₀₃, | Noise power at the comparison points of the Gaussian |
| P(a) | Gaussian form noise |
| Pw₁, Pw₂, Pw₃, | Comparison points of the Gaussian |
| P_{consi} | Set point power |
| Pₑ | Input signal power |
| Pₛ | Output signal power |
| TACAN | Tactical Air Navigation |
| UWB | Ultra Wide Band |
| VGA | Voltage Gain Amplifier |

### DETAILED DESCRIPTION OF PREFERRED AND OTHER EMBODIMENTS

The GNSS systems currently use frequency bands that are very close to the frequencies allocated to the DME radio navigation beacons. The GPS and future GPS frequencies are by band: E6 (1260-1300 MHz), L2 (1216-1240 MHz) and L5/E5a (1164-1188 MHz). The Galileo frequencies are: E6, E5a and E5b (1188-1215 MHz). The DME transmission frequencies are 1025-1150 MHz for an onboard interrogator and the ground beacons transmit in the 962-1213 MHz band (therefore in the GALILEO E5a and E5b and GPS L5 bands). The total band is divided into 126 channels and transmission and reception of a beacon are offset by 63 MHz. The channels are therefore spaced 1 MHz apart. They are pulse pairs, each with a spectral width of 300 kHz that are transmitted by the onboard interrogator. The ground beacons respond to them with a fixed delay of 50 microseconds and the receiver of the onboard interrogator then searches for the pulse pairs in response that have the correct spacing between them. The signal power transmitted by the ground beacons is of the order of 15 kW.

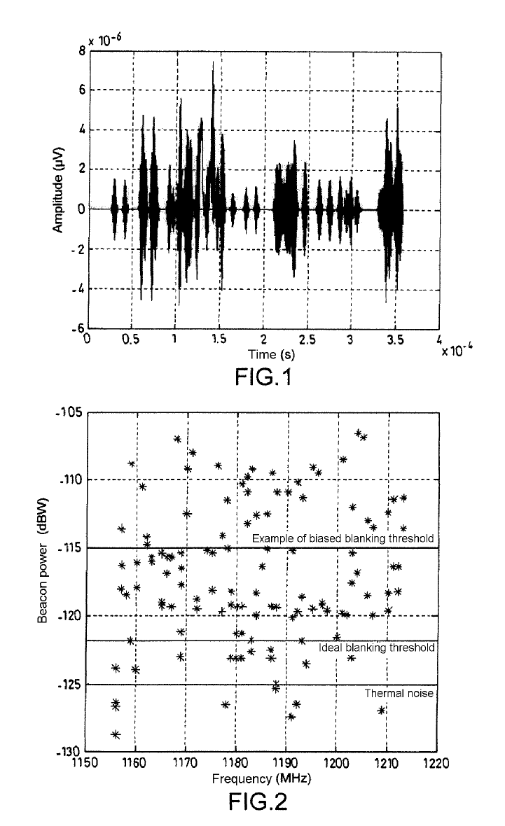

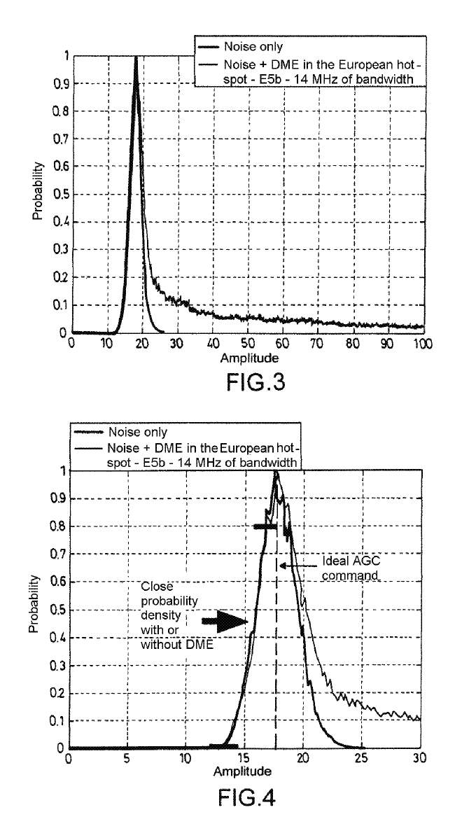

These operating features, schematized in amplitude/time in FIG. 1 explain the very disruptive character of the DME system for satellite navigation, all the more so when the occupancy ratio of the interference may reach 100% in environments that are very dense in beacons such as Northern Europe at high altitude.

FIG. 2 shows the number and power of the DME beacons in the allocated frequency bands that are very close to L5/E5a at the point of maximum density in the Northern European airspace called the “hotspot”. The aircraft gain is, for illustration purposes, fixed at −10 dBi in this figure. The figure also represents: an example of thermal noise level at the input (#−125 dBW), the blanking threshold resulting from the biased estimation of the thermal noise (#−115 dBW) and the optimal blanking threshold (#−122 dBW). The difference of 7 dB is very significant with respect to the performance demanded of the receivers.

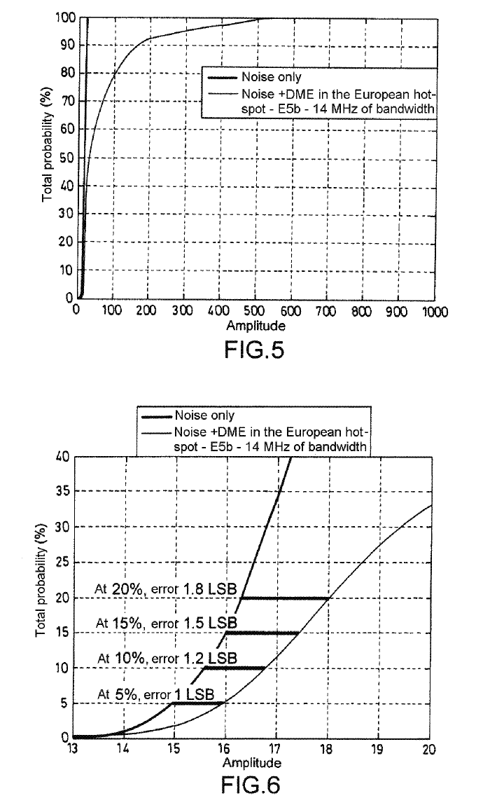

A GNSS signal is below the thermal noise. A minimal signal-to-noise ratio is essential for the processing of the signal, based mainly on correlations, where necessary aided, of the received elements and their local replies, to be effective. In particular, if the ADC is saturated by interference, the payload signal at the correlators will be extremely corrupted. This impossibility to achieve the payload signal is clearly illustrated in FIG. 5 which shows the power curves at the filtering output with and without DME interference. The time horizon is approximately 2 μs. Similar situations may occur in the presence of radars or ultra wide band (UWB) pulsed devices.

Currently, GNSS receivers use processes before correlation to process the pulsed interference, for example, the “blanking” method or the “FDAF” method.

Blanking is a simple process consisting in cutting the signal during the interference. The process cannot work when the interference is too dense because the payload signal is then completely lost. The FDAF method is an enhancement of this process. It consists in cutting up the reception band into subbands and in applying the blanking process to each subband.

However, these methods, although they make it possible to detect pulsed interference and eliminate it, assume that the power of the thermal noise is known precisely. For example, if a pulse has an amplitude greater than that of the noise, then it can be said with a low probability of false alarm that a pulse is present and it can be eliminated. This amounts to requiring an “ideal” AGC. In certain cases, it is possible to be mistaken on the knowledge of the power of the noise, without it bringing into question the effectiveness of the overall blanking or blanking by band. This is the case for scenarios in which the pulsed interference is very powerful and therefore easily detectable: the temporal methods work well because the pulses are detected and not taken into account in the estimate of the thermal noise. It is also the case in scenarios in which the pulsed interference is not very numerous and not very powerful: the estimate of the noise level is slightly biased but this does not prevent the working of the receiver, even though the latter is slightly degraded.

On the other hand, for scenarios in which the pulsed interference is numerous and not very powerful (difficult to detect), the estimate of the number of bits on which the noise is coded is greatly biased. The temporal methods are more effective (probability of non-detection very increased). Pulsed interference is detected relative to the estimate of the thermal noise. Since the estimate of the thermal noise is stronger than the thermal noise itself when not very powerful pulses appear and are not detected, the blanking threshold is therefore higher than it should be as illustrated in FIG. 2. Therefore pulsed interference enters into the computation of the AGC. The AGC reacts by reducing the gain of the VGA. Therefore, even more pulsed interference enters into the estimate of the thermal noise and so on. This continues to diverge until the receiver accepts the majority of the pulsed interference and no longer codes the payload signal.

This problem has been treated in prototypes. The idea has been to estimate the absolute thermal noise, to give an absolute blanking threshold and to see to it that the thermal noise does not change during the tests. In order to estimate the absolute thermal noise, the estimate of the gain of the HF chain is carried out by calibration in a laboratory and the estimate of the noise factor by measuring the noise of the chain with the antenna disconnected. This linking of two point-like measurements makes it possible to ascertain exactly the noise in the HF chain at a given moment and to carry out the blanking as a function of this noise estimate. Nevertheless, these devices are not operational because they are not robust in the event of the appearance of a continuous interference, ageing of the components or, notably, repeated thermal variations.

To solve this problem that is unresolved in the prior art, the idea of the invention is to enhance the estimate of the thermal noise and of the continuous interference in the presence of pulsed interference irrespective of its power and its rate of repetition. It is based on the principle that the low-amplitude filtered samples are not very sensitive to pulsed interference and that the characteristic of the thermal noise energy is virtually Gaussian, as shown in FIG. 4.

The aim of the AGC is to seek to detect the left portion of the histogram as represented in FIG. 4 and then extrapolate the command for the VGA. FIG. 5 represents the same data in total probability. In these figures, the choice has been made to represent the power probability function. The analysis of the received signal amplitude probability function could be used in a completely substitutable manner and would give equivalent results.

A close-up is carried out on the first portion of the curve (FIG. 6). The curves are similar but are not perfectly identical.

The principle of the invention is to determine the power of the noise by observing the histogram (or the amplitude probability function); this can be done by several methods:
breakdown of the histogram into the sum of laws of the khi2 (or approximated by a Gaussian in the case with optional filtering) and determination of the most probable representative of noise, for example, the greatest among the small amplitudes (criterion optimized according to the a priori environment);
breakdown of the histogram into the sum of a priori laws of the interferences and a law expected for the noise (Gaussian), the average of the noise law then being representative of the power of the noise alone;
calculation of a likelihood function by correlation with the expected form, in noise alone, possibly weighted a priori.

The calculation of the histogram must be done over a horizon that is sufficient to be representative.

The pitch of the histogram is chosen to be fine enough to discriminate the expected function (particularly its width equal to the standard deviation) of the other contributions generally closer to Dirac functions.

The filtering after comparison of the set point is not essential.

The component due to the noise is then determined and it is possible to compare its average with the set point value.

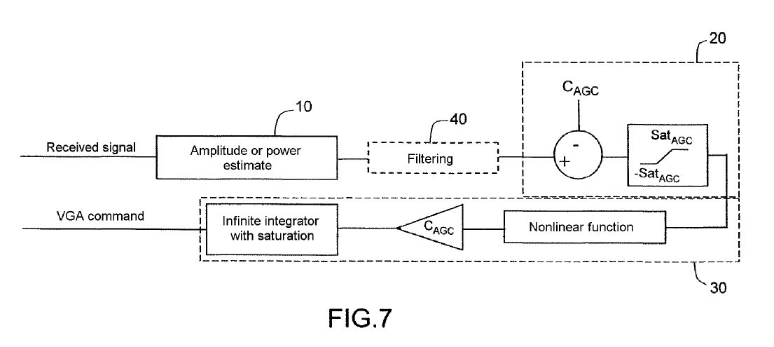

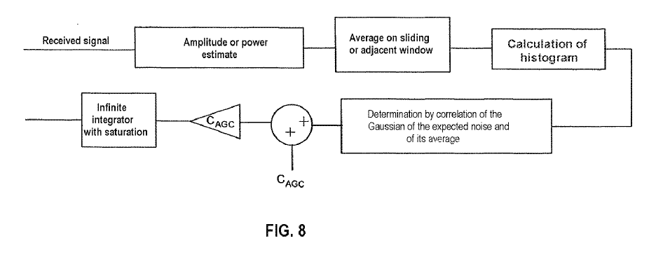

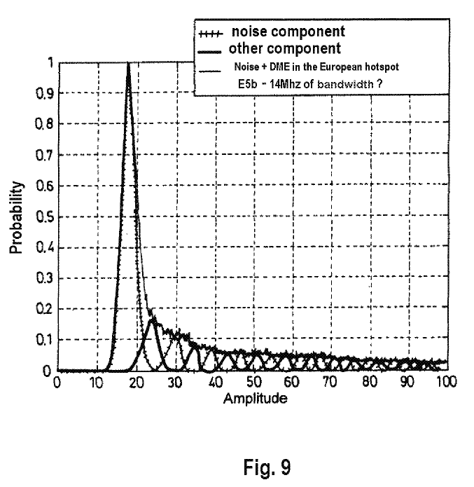

The architecture elements for implementing the invention are represented in FIG. 7. The device works advantageously in baseband. This makes it possible to have access to the instantaneous power of the pulses. The various functions represented in the figure are advantageously implemented in one and the same FPGA circuit. The first operator 10 is a conventional power estimation function of the I²+Q² type, (alternatively root amplitude (I²+Q²) or |I|+|Q|). The receiver conventionally comprises an AGC module 20. In a command module 30, one or more nonlinear functions are then applied to the outputs of the filter and they will generate an innovation based on optimality parameters that depend on the context of use. A filtering module 40 can optionally be provided. It will then be possible to carry out this filtering on an appropriate time horizon, for example 2.2 μs in E5b, which represents a sample of 128 points. The estimate is advantageously carried out on a standard deviation representing 10% of the average. Advantageously, the zeroes of the amplitude/power estimate (“zero” function) are not taken into account in the sliding average. Therefore, the outband pulses above the point of compression are neutralized. If the noise has a form P(a), the optimal nonlinear function is given by the formula

f(a)=(dP(a)/da)/P(a)

f(a) is a linear function when there are no pulses. In the presence of pulses, the linear function is retained in the left portion of the distribution which is, on the other hand, completely modified in its right portion. It is also possible to use a derivative of f(a).

The innovation is then introduced into the AGC. Finally, the noise processing parameters are determined. The device will of course be different depending on the chosen noise processing mode. Three processing modes will be described in the rest of the description. These modes form as many variants of the modes of locking in the AGC.

This device makes it possible to maintain the pursuit in code or in carrier of a GNSS receiver for air navigation on the E5a/E5b/L5 frequencies, notably in the European and American hotspots (pulsed interference). It operates in the presence of continuous interference. It is not sensitive to the change of temperature of the electronics. It also makes it possible to process pulsed interference of the radar type such as UWB. The FPGA implementation is low cost. In addition, the AGC is robust irrespective of the pulsed interference scenario.

The lock-on mode is first of all described in greater detail. FIG. 8 illustrates the means used to directly determine the histogram of the power probability function. The signal is broken down into elementary sums in order to identify the Gaussian due to the noise. This solution requires a precise knowledge of the pulses (form, probability). This solution is not very applicable to the onboard receivers but can be of interest for the fixed receivers, the environment of which is perfectly determined (constellation control station).

FIG. 11 illustrates one of the variants of this embodiment in which the histogram is broken down into a noise component according to an a priori law and a component carrying the other elements of the signal.

By using these different methods of applying the invention, biases of a few LSB may appear. Nevertheless, this bias is greatly acceptable because the bias is much less than that which appears with a conventional automatic gain control (6 to 7 dB).

Once the noise is known with a reduced bias, the interference is easily isolated. The simple blanking is then carried out by deleting the signal in the temporal range where the interference is present. Those skilled in the art know how to produce the device necessary to carry out this deletion.

To carry out a blanking by subband of the frequency domain, it is possible, for example, to provide a detection filter by subband. If the user has no theoretical knowledge of the characteristics of the interfering signals, he will use standard passband filters. If, on the other hand, the user knows the characteristics of the interfering signals (frequency and form of the pulses), he can use FIRs. Rejection filters then make it possible to chop the signal on the ranges where the interfering signals are present. A noise with reduced bias is estimated in each of the frequency subbands and this noise serves as a reference for deleting the signal received in each of the subbands.

A third mode of processing interference consists in inverting the amplitude or the power of the received signal, the high amplitude/power interference then being peak limited. Amplitude or power inversion consists in multiplying the input signal by the inverse of the estimate of filtered amplitude or power. If the inversion relates to the signal power, the output signal power is equal to the inverse of the input signal power, to within one constant. The receiver gain is given relative to a set point power by the formula:

G=P_{consi}/Pₑ

If the inversion relates to the signal amplitude, the output signal power is equal to the inverse of the square of the input signal power, to within one constant. The receiver gain is given relative to a set point power by the formula:

G=(P_{consi}/Pₑ)²

Power inversion is theoretically optimal. On the other hand, amplitude inversion is less sensitive to the imperfections of implementation. Power inversion may not however be a complete substitute for blanking: when the ADC is saturated by pulsed interference, it is necessary to carry out blanking in order to limit the parasitic frequencies which otherwise would enter into the correlation. For this reason and to have a reference to fix P_{consi}, it is necessary to have an unbiased noise reference. The set point at which the product of the source and inverted signals is locked on is made up of the noise estimate made by the device of the invention. It is possible to carry out an inversion by frequency subband. The latter process is particularly advantageous for BOC (Binary Offset Carrier) signals for which the user carries out the inversion on four frequency bands (two wide bands and two narrow bands).

Other modes of processing noise are possible at the output of the optimal command of the AGC which makes it possible to estimate the thermal noise with a reduced bias. The invention is therefore not limited to the embodiments disclosed in the present description.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A device for receiving a radio signal comprising a module for estimating a characteristic magnitude of said signal chosen from the group amplitude, power, an automatic gain control module of the receiver, and a module for analyzing the probability density function of said characteristic magnitude whose parameters can be adjusted to supply inputs to the automatic gain control module which ensure a substantially optimal gain of the receiver, wherein the probability density function analysis module comprises a sub-module for calculating an averaged histogram of said function and a sub-module for determining the noise by comparison to an a priori chosen statistic.

2. The reception device of claim 1, wherein said noise determination sub-module performs a breakdown of the histogram into a sum of laws of the X² and determines the one that is the most probable law representative of the noise.

3. The reception device of claim 1, wherein the noise determination sub-module performs a breakdown of the histogram into a sum of laws expected for the interferences and laws expected for the noise.

4. The reception device of claim 1, wherein the noise determination sub-module performs a correlation of the histogram of the signal with a histogram of the noise according to an expected law.

5. The reception device of claim 1, further comprising an interfering signal processing module at the output of the probability density function analysis module.

6. The reception device of claim 5, wherein the interfering signal processing module carries out a blanking whose threshold is calculated by reference to the noise estimated by the probability density function analysis module.

7. The reception device of claim 5, wherein the interfering signal processing module carries out several blankings in frequency subbands of the signal, each blanking threshold being computed by reference to the noise estimated by the probability density function analysis module.

8. The reception device of claim 5, wherein the interfering signal processing module carries out an inversion of a characteristic magnitude of the chosen signal in the group amplitude, power based on the output of the estimation module.

9. A method for processing a radio signal comprising a step of estimating a characteristic magnitude of said signal chosen in the group amplitude, power, a step of controlling automatically the gain of the receiver and a step of analyzing the probability density function of said characteristic magnitude whose parameters can be adjusted to supply inputs to the automatic gain control step to ensure a substantially optimal gain of the receiver, wherein the probability density function analysis step comprises a sub-step for calculating an averaged histogram of said function and a sub-step for determining the noise by comparison to an a priori chosen statistic.
